(19) United States
(12) Patent Application Publication
(10) Pub. No.: US 2022/0262187 A1
(43) Pub. Date: Aug. 18, 2022

(54) Non-Binary Circuit Assembly For Voting Terminal

(71) Applicant: Thomas Wilfred Pye, Lindale, GA (US)

(72) Inventor: Thomas Wilfred Pye, Lindale, GA (US)

(21) Appl. No.: 17/177,243

(22) Filed: Feb. 17, 2021

(51) Int. Cl. G07C 13/00

(52) U.S. Cl. CPC G07C 13/00

(57) ABSTRACT

The preferred embodiment of the invention is realized as a compact electrical terminal that is connected to a tabulation device for use in a political election. The invention keeps the voter in charge of sorting and counting their decisions. It is of low cost and it does not involve computers or internet connections. On command from a switch the terminal decodes a paper perforated ballot and transfers the chosen decisions to the real-time tabulation means for as many candidates in as many races as decreed. Incorrectly formulated ballots can be cured by the voter before the vote is final. Succeeding voters add to the on-going totals of their chosen candidates until all have voted, and the entire process is thereby over at that moment.

### BACKGROUND OF THE INVENTION

Proper elections require mistake-free voting terminals. Each vote must be cast, sorted, and counted. This is self-evident in that no cast vote can be counted unless it is first sorted into the on-going column of a given candidate or issue. Prior art voting machines deprive the voter of direct control of the sorting and counting of their overall votes. With the instant invention. the voters themselves complete all three of the stages to a proper election.

For accurate claiming delineation, the common English word ‘deriving’ must be clarified. The inclusion of the possible placement of a transmigrating element in an electrical system is recognized by the precise term ‘deriving’: “A first element or defined location connected to raw current deriving from a second element or defined location” indicates there may be a third transmigrating element or a plurality of elective elements between the first and second defined element, or the third transmigrating element may be somewhere else in the circuit. What is established by the use of ‘deriving’ is that (relative to current flow direction positive to negative in the claimed electrical circuit assembly) the first cited element comes after (subsequent to) the second cited element regardless of possible intermediate transmigrating elements or elective elements arbitrarily placed between them. A charge through the first cannot pass through the second.

There are novel differences between the instant invention and the prior art. To provide distinct claims, the four terms ‘non-binary’, ‘modicum of intent’, ‘atad’ and ‘decodeasorting’ are introduced to label four concepts with no equivalence in the English language.

Typically modern voting machines feature a touch-screen computer interface and utilize a series of electrical pulses that have durations of time pass between the end of one pulse and the start of another. This relies on the science of binary encoding and the rules of a binary language, which is symbolized by two conditions: high 1 or low 0. A series of pulses becomes digital information. Thus the governance of digital information by computerized binary software allows the operation of an electrical binary apparatus. However, a single electrical pulse of electricity is not enough pulse activity to qualify as binary encoding. A single pulse of electricity, whatever its time duration may be, is termed raw current or an electrical charge. An apparatus or circuit assembly dependent solely on raw current signals, and without the presence or governance of digital information, is herein termed an electrical ‘non-binary’ apparatus or circuit assembly.

A modicum is a small quantity of a particular valuable thing such as intellect. A ‘modicum of intent’ is a physical manifestation of a person's decision to memorialize a choice between several choices to resolve a contested issue or contest. In a political election a blank ballot is not a modicum of intent until relevant data is entered on or into it at a designated graphical portion of the ballot. Decoding can be by visual, tactile, photo-optic, or mechanical detection. For example, ink marked ballots or perforated ballots are two common ways a voter can transform a blank ballot into a modicum of intent. Negative expression on a ballot (the voter marks out candidates they do not want) and positive expression (the voter marks in candidates they do want) are different protocols. Examples for both types of decoding protocols will be shown, one type using only mechanical means (a lever) and another type using electrical means (a switch).

The choices for one political contest are collectively termed data supersets. A single affirmative decision on a ballot becomes a data entity realized from one of the possible choices (i.e. the data superset) for a contest. Unselected choices are tenned ‘atads.’ To decode data without computers, there must be information to gather and information to ignore. An atad exists as a foil to the data entity. It has a physical presence as well as independent electrical components to support it. In fact, all points of a data superset have isolated strinus of support throughout the instant voting terminal. What is an atad for one voter may be a data entity for another.

The isolated-bus safety feature requires each circuit to be in effect hard-wired from beginning to end, and is completely at odds with the bifurcating expansion of a binary system. There, all of the data from a computer screen is digitally collected, encoded as a sequence, and then transmitted in serial data fashion (frequently over the same electronic bus) to a myriad of destinations for unpacking. This binary lack-of-isolation defect lowers data entity preservation because it is possible to lose or add a 0 or 1 or a plurality of them, termed a glitch. In contrast, a single physical action on the decoding means of the instant terminal both separates the data entities from the atads and simultaneously sorts each data entity (for subsequent tallying) with a reliable result. There is no inclusive English term in the election apparatus art for an accurate outcome of this nature from one unique user action. This capability is termed ‘decodeasorting.’ The data entity as an electrical charge is released for tabulation or placed into a storage medium such as a capacitor.

As claimed herein as novel, useful, and unobvious: a non-binary decodeasorting circuit assembly has interfacing means (for receiving data entities created at designated locations on a modicum of intent), has decoding means (to identify those data entities), and has sorting means (to transmit those data entities) isolated on a dedicated non-binary bus. As such, the confluence of elements is a voting terminal. A plurality of the instant terminal bus outputs connected to a plurality of dedicated count and tally devices suffice to empower an entire election. The premier benefit is a data entity for Candidate A can never enter the electrical path for Candidate B, and vice versa. For voting integrity with an electrical machine, this accurate use of the word ‘never’ underscores a powerful innovation. In elections with binary involvement, voting integrity will be frequently compromised even if only programming and hardware-induced glitches are considered.

### SUMMARY OF THE INVENTION

The first object of the invention is to supersede every known electric voting machine in lowering the determinative parts count, which lowers the hardware costs. As such, it will become the most dependable yet inexpensive electrical voting terminal ever offered to governments to date.

The second object of the invention is to provide a voter the control of where each data entity is tabulated to fulfill the sorting process. Meanwhile, the atad is unable to command a pulse response at the counter electrically designated for that atad. It is a benefit of the invention that an atad is always latent but never realized, in the way a data entity is always realized and never latent. Thus, the invention preserves voter intent. It is inescapable that binary voting machines perceptibly sort data entities into tabulation columns for unchosen candidates (atads) and vice versa, because there is no way to prevent it under glitch probability expectations. Both software and hardware mistakes are culpable in this malfeasance. Therefore:

A third object is to eliminate the use of computers in the core voting process by limiting all lines of electrical transmission down to an isolated single pulse of raw current, which may or may not be captured and later released. Without computers, the accuracy of instant results indicates that the need for a recount is reduced to high degrees of improbability.

A fourth object is the use of transmigrating bus control means to allow many dozens of terminals to be strobed to release the data entities to the counters in an orderly fashion. As such, the results rendered by multiple terminals are as valid and safe as the results of a single terminal.

It is a fifth object of the invention to employ transmigrating cross-control interruption means that shut down the process when the ballot data is inadequate. An example is when the voter has perforated holes for a plurality of candidates in a single contest when only one perforation is permitted per contest. If it happens, a process interruption ensures that neither circuit passes current. The user must then cure the ballot and re-cast it to move forward in the process. The benefit is that the true votive intent is always tabulated. Prior art second party stages of an election involve the sorting and counting of the ballot, and the ballot must have one data entity per contest or it is discarded by the second party. This loss of the voter's intent is why the use of paper ballots fell out of favor decades ago and election machines were equipped with other decoding elements, such as touch-screens, where users could hopefully correct their mistakes.

These and other objects and features are achieved in a system that is arranged and operated in accordance with the drawings, specification, and claims.

### BRIEF DESCRIPTION OF THE DRAWINGS

FIG. 1 is the basic embodiment for a voting circuit assembly using photovoltaic decoding means. Shown with housing, it is a non-binary terminal able to increment either of a set of dedicated electromechanical counters. In this minimum configuration, two identical circuits implement the voter's choice of a data entity and an atad. It has one user action (termed single action) that combines data entity sorting means and data entity command means into one instant of time. This instant terminal will work fine in small precincts with up to about 100 voters. Large precincts (with thousands of voters) will find better use of terminals with expanded capabilities (such as in FIG. 2 and FIG. 4) that can be strobed and cascaded with other identical terminals. It has cross-control interruption means so a user cannot vote for two candidates in the same race.

FIG. 2 is also a single action embodiment. It has bus control means. When working in tandem with one pulse sequencer, a plurality of terminals can be strobed and commanded as to when one of them can increment the external counting means without interference from the other terminals.

FIG. 3 is a double action terminal (two user actions are required). Relative to the embodiment of FIG. 1, the two opposing dedicated circuits each have two additional elements and the circuit governance itself has one additional manually-triggered element.

FIG. 4 is the preferred embodiment. It has the elements of FIG. 3, adds cross-control interruption means, and adds bus control means. The latter conies from a logic gate and a pulse generator. This means many thousands of voters can be smoothly handled in one day in a single building.

FIG. 5 is a voting terminal with non-electrical sensor means. The two minimum circuits are similar to those of FIG. 3. As a variation, it substitutes the ends of a lever as the decodeasorting means instead of a manual switch. The levers both secure and lower the perforated ballot onto an array of solid spacer rods. The outer ends of two opposing levers could be ganged to move the ballot by a single lever's action (not shown), or constructed as one lever with an opposing bifurcated end (not shown). Where there is no ballot perforation, a solid spacer is forced down to engage an electrical switch that sorts the data entity vote into an accumulator. The spacers and ballot are shown in position before engagement. As another variation, the direct current power source is mounted within the terminal.

FIG. 6 is the same voting terminal shown in FIG. 5. Here the lever ends, spacers and ballot are shown after engagement. This levered embodiment illustrates means to decode perforated modicums of intent that do not use photovoltaic sensors. It also is a good example of the use of negative expression to place perforations in the ballot for the candidate on the ballot that the voter does not want, as per the voting protocols established for that particular country's election.

FIG. 7 is a double action embodiment resembling that of FIG. 3. For more variations, it features alternate data entity command means, with two elements acting in tandem to replace a typical manual switch. It has another form of voter secrecy with the counting means mounted within the terminal enclosure. It has a different way to interrupt two data entities when one is mandated. The seven drawings show component discussion elements listed (1-37) for various embodiments.

### DETAILED DESCRIPTION OF THE INVENTION

FIG. 1 shows a plurality of photovoltaic sensing means (4) for a perforated ballot (1) placed on the data interfacing means (2) of an organizational substrate. A manual switch (5) is connected to both of the two competing candidate's circuits from the power source (6). The first circuit (as an example) conveys raw current if the manual switch (5) is closed, because the sensor (4) is exposed to light (3) by the ballot (1). The current signal first goes to an incoming port of dedicated current switching means (7) and on to an output interface node (10) shown contiguous with a designated counting means (8). The circuit's light sensors (4) are the decoding means and the switching means (7) are the sorting means. At points along a current bus, a node (10) represents a potential breakpoint along that bus. Thus the node (10) is not a definitive element of the circuit. It signifies if a junction of the bus is present there, the two contiguous ends of the bus can become separated. If separated, the ends cannot convey current. If brought back into contact, they can. Node ends can be improved into socket and pin connectors (not shown). A load resistor (9) is depicted to represent other circuit conventional elements such as limiting resistors, diodes, noise-filtering strategies, etc, which are not shown. Such associated support items are not determinative to the instant invention. The second circuit elements of the instant terminal are identical and independent to the first circuit elements and do not have numerical citation. Switches that light up (when flipped on) are a common prior art on voting machines. Such operator alert means announce circuit activity or non-activity to a voter. For a first example, a light emitting diode (31) with the anode pin in electrical contact with a node (11) illuminates any time the switch (5) is passing current. For a second example, an extra display counter (37) exactly like counting means (8) can be placed external and adjacent to the terminal to alert the voter (when it does not increment) that no vote has taken place. The counter (37) is controlled by the output of an X-OR (exclusive-or) logical gate (36), which releases a trigger pulse anytime one of the plurality of counting means (8) increments. As a momentary example, the second circuit shows a candidate with 28 votes on the associated counting means, versus the 46 votes for the candidate of the first circuit. Totaled together, they show 74 votes on the tabulator counting means (37). For additional candidates than two in a contest, more circuits can be added to the output of the switch (5) by attaching an extra continuation bus (not shown) to the current node (11). These additional circuits will be identical in component elements to the two example circuits shown for this embodiment. The triad of interconnected current switching means (12, 13, 14) are the supporting elements of cross-control interruption means, employed to interrupt the voting process if the voter has voted for two candidates in the same race. If desired, other logic chip arrangements can be employed to detect if the voter has failed to select any candidate in a given contest (not shown). The one manual switch (5) is not a subject within a circuit, it controls the plurality of circuits. Together, the switch and the plurality of circuits form a circuit assembly, which is a collection of electrical components oriented in a defined interrelationship. In this FIG. 1 depiction, the second circuit happens to be blocked from ambient light activation by an unperforated portion (35) of the ballot and represents the atad circuit. The terminal only requires one user action to complete the process.

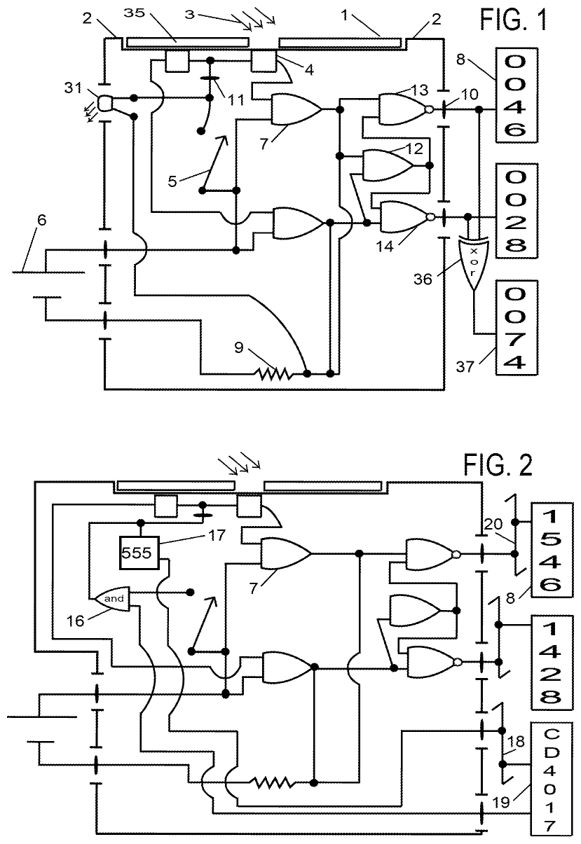

FIG. 2 is a more enhanced single action embodiment than detailed in FIG. 1. It features the addition of two bus control elements: an AND logical gate (16) and a pulse timer semiconductor (17) such as the 555 pulse generator. These two elements work in non-binary fashion sending a pulse through a first summing bus (18) to an external strobed pulse sequencer (19) such as the CD4017 microchip. The bus (18) runs to all other terminals (not shown) and allows any given strobed terminal to shut down the global strobing sequencer (19) if that strobed terminal is ready to deliver a data entity pulse to the exterior dedicated counter means. In like fashion the data entity transfer summing bus (20) passes the pulse deriving from the switching means (7) to the dedicated counter (8). All other terminals (not shown) with a data entity destined for this particular counter (8) will use the same transfer summing bus (20) to increment the counter.

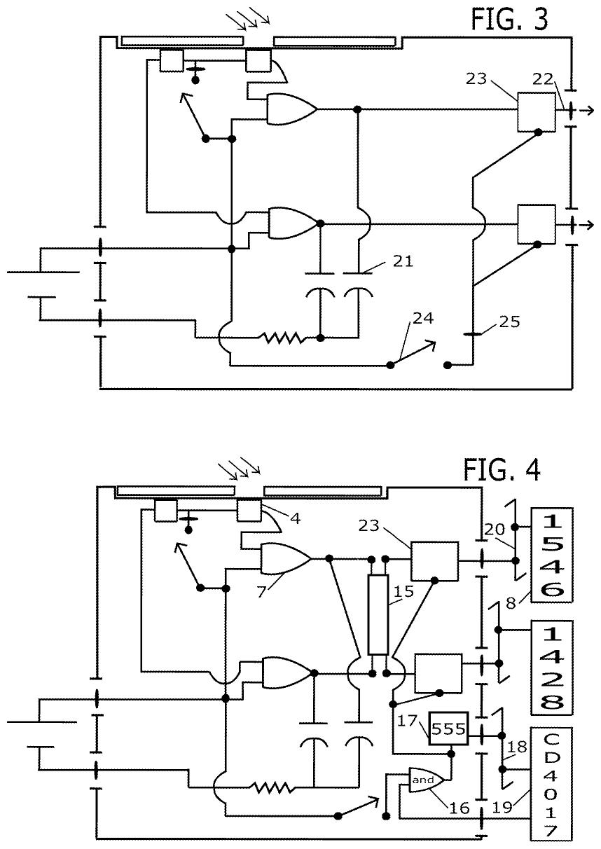

FIG. 3 is a basic embodiment of the instant invention that requires two user steps after casting the ballot. It has three new elements not seen in FIG. 1. Independent from the two isolated bus circuits, manually controlled data command means is present and represented by a single activation switch (24). This second manual switch (24) has secondary master control governance over both the depicted voting circuits. It releases the data entity current stored in an accumulator (21) to the output port (22) of a depicted switching means (23). The activation switch (24) does this by sending a command to both of the current switching means through a signal bus having a node breakpoint (25). As is the potential nature of nodes, it can be separated and the exposed ends can become wired to an external electrical device, such as a computer or other strobing circuitry. This node represents an opportunity to bring timing governance to a plurality of these terminals for use in large precincts with many voters.

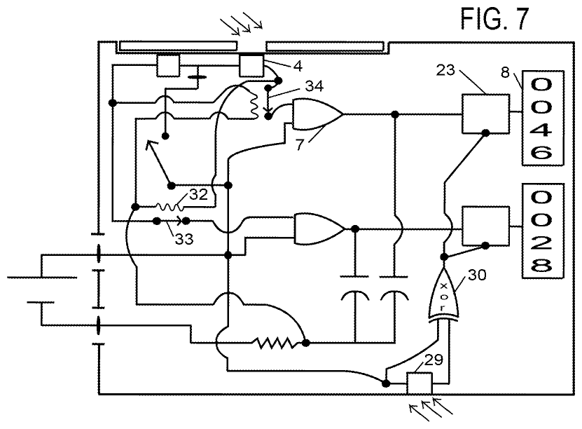

FIG. 4 is the embodiment of FIG. 3 further enhanced by the addition of the same timing circuitry described in FIG. 2, but in a different transmigrated circuit location. This entails an AND logical gate (16) and a pulse timer semiconductor (17) connected to a pulse sequencer (19). Another circuit feature, transmigrating cross-control interruption means (15), is shown arbitrarily oriented in the circuit to be following the current switching means (7). As shown in FIG. 7, another embodiment has a different type of interruption means oriented in the circuit before the switching means (7). Either transmigrated orientation (before or after) would work just as well.

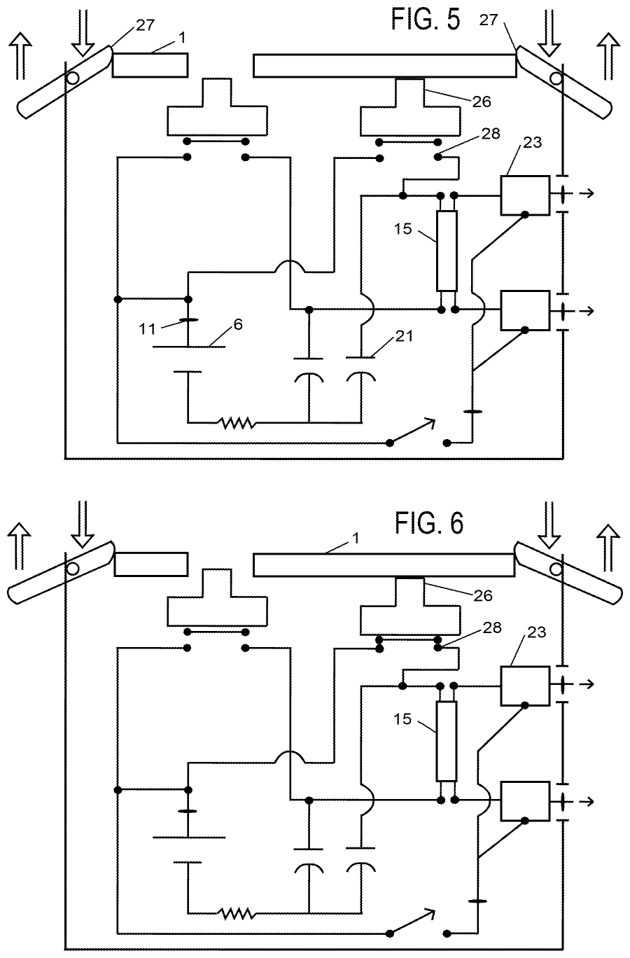

FIG. 5 has non-electrical sensor means suitable to trigger the data entity circuit depicted in FIG. 3. It operates with a perforated ballot (1) inscribed via negative selection. This means the data entity is revealed as the non-perforated candidate. The perforated location of the data superset decodes as an atad. The upper end of a solid spacer (26) (such as a rod) will either move untouched through a perforation (an atad) or be lowered by the solid undersurface of a non-perforation (a data entity) when the stiff ballot (1) itself is lowered by a lever (27) action. When a chosen spacer does go down, it triggers a spring action pushbutton switch (28) that closes the two ports and lets raw current flow to the anode of the accumulator (21) and to an incoming port of the switching means (23). That is, unless the other circuit incoming port is also high, as determined by interruption means (15). The unselected rods stay motionless as their tops pass through the atad perforations. The plurality of spacer rods are fixedly secured above the switches, or may be an integral part of the actuator of the switch itself The spacers are aligned with the chosen data entity and at least one atad when the ballot (1) is placed atop the lever (27) inner ends.

FIG. 6 is another moment in time viewing the embodiment of FIG. 5. The lowering of the ballot (1) has forced down the spacer (26) and closed the switch (28). In the event that two spacers are down together by error of the voter (not shown), both circuits are unable to conduct a charge through the switching means (23), as cross-control interruption would be in effect.

FIG. 7 is the embodiment of FIG. 3 with the presence of three variations for claiming purposes. This embodiment features the interior placement of a count and tally apparatus (8) for each of the two isolated bus circuits. Counters like this increment the standing count with a trigger pulse of electricity. The manually controlled data command means is still present but herein represented by a photovoltaic sensor (29) controlling current through an X-OR (exclusive-or) logical gate (30). Only when the sensor is cut off from light (for example by a finger placed over it) will the switching means (23) transmit a raw current signal. This depicted data control means is effectively another way to switch on a subject circuit. For a different example of interruption means, the sensor (4) passes current through the activator (32) of a normally closed solid state relay switch (33). In the same manner, if the second circuit also tries to send a data entity current when the first circuit's sensor means is activated, the opposing normally closed relay switch (34) is also opened and neither circuit can pass a data entity. This differs from the interruption means seen in FIG. 1 in that this relay design automatically blocks current in an opposing circuit whether the opposing current is active high or not. In the FIG. 1 embodiment, if a first circuit goes high, the opposing current is not affected unless both circuits go high. The family of relays includes not only electromechanical ones but myriad electrical solid state devices that open or close a bus under command, such as opto-isolators and their variants like optocouplers. Unless critical to element connectivity, all semiconductors are depicted without power and ground pins to prevent clutter in the drawings.

### SUMMATION

The instant invention serves as the circuitry for a voting terminal in an election using perforated ballots. The terminal can be populated with many dozens of isolated circuits for as many contests as desired, with any plurality of candidates running in a given contest. At the minimum, one user action does everything needed to ensure voter intent is both secret and accurate. Interruption means allow the voter to retrieve, cure, and recast an improper ballot before the counting happens. Thus the number of votes cast (in any given race) from the terminal (when totaled together) will not exceed the number of voters having used that terminal. The counter (37) seen in FIG. 1 proclaims the voters one by one in real time. When finished, the voter turns the terminal over to a next voter.

The instant invention empowers a complete voting apparatus and is not to be confused with prior art ballot-counting apparatuses, where outside activity is mandated. Therein precinct ballots must be brought (after casting) to a counting apparatus where workers employ second party means to decode the ballots and increment tabulation, i.e. sort and count. Because all wrongly perforated ballots are disqualified and discarded as a rule, voter intent is lost and can never be restored. This is a serious uncorrectable defect of a ballot-counting apparatus.

The double action embodiment has at minimum: a single manually instigated decodeasorting means, a single manually instigated data entity command means, and for each data entity circuit a plurality of decoding means, sorting means, accumulators, and current switching means. Perforated ballots can be sensed with compressed air, sonic means, and means such as described herein. In the first example the optical means are the sensors and the electronic switch is the sorting means. In the second example the spacers are the sensors and the mechanical switch is the sorting means.

The accumulator in the preferred embodiment is an electrolytic capacitor; however, fast-draining rechargeable batteries can be employed as a chemical alternative to charging plate technology. The plurality of data entity command means are typically relays or solid state switching technology. Three examples of the manually instigated current switching means would be a lever throwing a switch, a manual switch alone, or sensing means whereby ambient light is blocked with a finger. The instant invention can pass the sorted affirmative choices of the voter through a passive socket-to-plug interface to a dedicated electromagnetic counter. However, these choices could also be sent from the current switching means to an alternate count and tally apparatus such as a binary computer or other device capable of data entity summation.

The bus control means can be either non-binary (as shown) or binary. A binary example of bus control means is a computer with a dedicated pair of current buses to each terminal. When one of these buses changes logic as a result of a manually triggered signal, the computer will use the other bus to send an exclusive signal to the terminal to release the sorted signals to the counters. However, binary computing means are not preferred elements, as the confidence of the voter in the election returns will increase with completely non-binary voting machines.

In the drawings, the depicted presence of any particular element within the confines of a housing is not a narrowing factor in the presentation of an electrical circuit, as any particular determinative element can be placed outside the depicted housing as well as inside. The housing is a type of organizational substrate. In electronics, an organizational substrate is a physical anchor to which determinative elements are ordered by, and could as well be a two-dimensional plank as easily as the three-dimensional box depicted in the drawings. In this case, a plank housing (such as a printed circuit board) has no inside, only an outside. The words ‘terminal’ and ‘machine’ refer to the means by which the cited determinative elements are ordered or anchored. By convention, in the seven drawings various cited elements are shown as inside or outside the housing as examples of possible variation where there is a full enclosure for the circuit assembly.

This invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

I claim:

1. A non-binary decodeasorting electrical circuit assembly; said assembly with data interfacing means to secure a perforated modicum of intent; said assembly with a plurality of signal output interfacing means, comprising:
a plurality of sensor means; said sensors optoelectronic devices; said sensors with a current source end and a current release end; said plurality of sensors aligned with at least one data entity and at least one atad as positioned on said perforated modicum of intent;
manually instigated sorting means; said sorting means an electrical switch; said switch with an input pin for a power source and an output pin connected to said current source end of said plurality of sensor means; said current release end of said sensor passing an electrical charge in the presence of light and said power;
transmigrating cross-control interruption means; said transmigrating cross control interruption means deriving said electrical charge from said plurality of sensor means; and
a plurality of first multi-port current switching means; said switching means deriving said electrical charge from said release end of said sensor; said output interfacing means deriving said electrical charge from said first multi-port switching means.

2. A non-binary circuit assembly according to claim 1, said interruption means three logic devices;
said three devices an AND gate and a plurality of NAND gates; said AND gate and said NAND gates each with an output and a minimum of two inputs,
said output of said NAND gate conveying said electrical charge deriving from said sensor; said output of said AND gate connected to a first input of a first NAND gate and to the first input of a second NAND gate; each of said first and second NAND gates connected at said second input to said electrical charge deriving from said current release end from a first and second of said sensors;
both of said inputs of said AND gate also connected to said electrical charge deriving from said current release end from said first and second sensors, whereby when the same high current logic state is present at said two input ports of said AND gate, said output port of said AND gate deactivates said output of said plurality of NAND gates.

3. A non-binary circuit assembly according to claim 1, further comprising:
a second multi-port current switching means with at minimum a control port and an input port and an output port, and
a pulse generator; said pulse generator with an activation port and a signal-out port;
said output pin of said electrical switch connected to said control port of said second multi-port current switching means;
said output port of said second multi-port current switching means connected to said activation port of said pulse generator;
said output port of said second multi-port current switching means also connected to said plurality of said sensor means.

4. A non-binary circuit assembly according to claim 3, together with a strobing pulse sequencer;
said pulse sequencer with a plurality of daisy-chained pulse output pins and a cease operations pin;
said cease operation pin deriving electrical command from said signal-out port of said pulse generator;
one of said plurality of daisy-chained pulse output pins of said pulse sequencer connected to said input port of said second multi-port current switching means;
said second current switching means follows a logic combination state whereby having raw current present at said input port and present at said control port dictates said output pin commands said cease operations pin by action of said pulse generator and also commands said plurality of first current switching means,
with the benefit that under control of said pulse generator said first multi-port current switching means is optimized relative to time for transmitting said electrical charge to said output interfacing means.

5. A non-binary circuit assembly according to claim 1, further comprising:
a plurality of accumulators; said accumulator deriving said electrical charge from said plurality of first multi-port current switching means;
manually instigated data command means; and
a plurality of second multi-port current switching means; said switching means deriving said electrical charge from said accumulator; said switching means controlled by said manually instigated data command means to transmit said electrical charge to said signal output interfacing means.

6. A non-binary decodeasorting electrical circuit assembly; said assembly with data interfacing means to secure a modicum of intent; said assembly with a plurality of signal output interfacing means; comprising:
a plurality of sensor means; said sensor means aligned with at least one data entity and at least one atad as positioned on said modicum of intent;
a plurality of sorting means; said sorting means electrical switches;
a plurality of accumulators;
manually instigated decodeasorting means; whereby said data entity is captured by said sensor means and transmitted through said electrical switch as an electrical charge to one of said accumulators; and whereby said atad is not captured and transmitted as an electrical charge to another of said accumulators;
a plurality of first multi-port current switching means; said first current switching means each with an output port and at least a first and second incoming port; said first incoming port deriving said electrical charge from one of said accumulators; and
manually instigated data entity command means; said second incoming port of said plurality of current switching means deriving an electrical signal from said command means; whereby said captured electrical charge is released from said accumulator to said output port of said multi-port current switching means,
said signal output interfacing means deriving said electrical signal from said output port of said multi-port current switching means.

7. A non-binary circuit assembly according to claim 6,
said assembly together with transmigrating cross-control interruption means; said interruption means deriving said electrical charge from said plurality of said sensor means.

8. A non-binary circuit assembly according to claim 7,
said interruption means a plurality of normally closed relays; a first of said relays deriving said electrical charge from a first of said sensor means and a second of said relays deriving another of said electrical charge from a second of said sensor means; said normally closed relay with activation means and switching means; said normally closed relay under command preventing said electrical charge from reaching said first current switching means; said output port of said first of said sensor means connected to said activation means of said second relay; said output port of said second of said sensor means connected to said activation means of said first relay,
whereby electrical charge activation of said first and second of said sensor means opens said switching means of said first and second normally closed relays.

9. A non-binary circuit assembly according to claim 6, said plurality of sensor means optoelectronic devices; said device with a current source end and a current release end;
said plurality of electrical switches a plurality of logic devices; said logic device with an output and a plurality of inputs; said logic device deriving said electrical charge at a first input from said current release end of said optoelectronic devices; said logic device connected at a second input to a source of raw current; said accumulator deriving said electrical charge from said output of said logic device;
said manually instigated decodasorting means a single electrical switch; said single switch with an input port for a power source and an output port connected to said current source end of said plurality of said optoelectronic devices.

10. A non-binary circuit assembly according to claim 6, said manually instigated decodeasorting means a lever; said lever in contact with said modicum of intent; said sensor means a plurality of solid spacers each contiguous with one of said electrical switches; said switch with a first port and a second port; said switch triggered by external pressure from said modicum of intent on at least one of said solid spacers; said electrical switch connected at said first port to raw current; said accumulator deriving said raw current from said second port.

11. A non-binary circuit assembly according to claim 6, further comprising:
a second multi-port current switching means with at minimum a control port and an input port and an output port, and
a pulse generator; said pulse generator with an activation port and a signal-out port;
said data entity command means connected to said input port of said second multi-port current switching means; said output port of said second current switching means connected to said activation port of said pulse generator and also connected to said plurality of first multi-port current switching means.

12. A non-binary circuit assembly according to claim 11, together with a strobing pulse sequencer;
said pulse sequencer with a plurality of daisy-chained pulse output pins and a cease operations pin;
said cease operation pin deriving electrical command from said signal-out port of said pulse generator;
one of said plurality of daisy-chained pulse output pins of said pulse sequencer connected to said control port of said second current switching means;
said second current switching means follows a logic combination state whereby having raw current present at said input port and present at said control port dictates said output pin commands said cease operations pin by action of said pulse generator and also commands said plurality of first current switching means,
with the benefit that under control of said pulse generator said first multi-port current switching means is optimized relative to time for transmitting said electrical charge.

13. A non-binary circuit assembly according to claim 6, together with a plurality of count and tally apparatus;
said apparatus deriving said electrical charge from said signal output interfacing means; whereby said electrical charge instivates an incremented status condition change from the prior status condition within said apparatus.

14. A non-binary electrical circuit assembly; said assembly with data interfacing means to a modicum of intent; said assembly together with said interfacing means an election voting terminal;
comprising:
a plurality of sensor means;
a plurality of sorting means;
manually instigated decodeasorting means; said sensor means and said sorting means passing a minimum of one electrical charge as the result of a single operator command of said decodeasorting means;
a plurality of accumulators;
a plurality of first current switching means; said switching means with an output and at least a first and second incoming port; and
manually instigated data entity command means, said sensor means deriving said electrical charge from said decodeasorting means;
said sorting means deriving said electrical charge from said sensor means;
said accumulators deriving said electrical charge from said sorting means;
said current switching means deriving an activation signal from said data entity command means;
said current switching means deriving said electrical charge from said accumulators; said current switching means passing said electrical charge through said output under command of said activation signal.

15. A non-binary circuit assembly according to claim 14, said assembly together with transmigrating cross-control interruption means; said interruption means deriving said electrical charge from said plurality of said sensor means.

16. A non-binary circuit assembly according to claim 15,
said cross-control interruption means a plurality of normally closed relays; a first of said relays deriving said electrical charge from a first of said sensor means and a second of said relays deriving another of said electrical charge from a second of said sensor means; said normally closed relay with activation means and switching means; said normally closed relay under command preventing said electrical charge from reaching said first current switching means; said output port of said first of said sensor means connected to said activation means of said second relay; said output port of said second of said sensor means connected to said activation means of said first relay,
whereby electrical charge activation of said first and second of said sensor means opens said switching means of said first and second normally closed relays.

17. A non-binary circuit assembly according to claim 14, said plurality of sensor means optoelectronic devices; said devices with a current source end and a current release end;
said sorting means a plurality of logic devices; said logic device with an output and a plurality of inputs; said logic devices deriving said electrical charge at a first input from said current release end of said optoelectronic devices; said logic devices connected at a second input to a source of raw current; said accumulator deriving said electrical charge from said output of said logic device;
said manually instigated decodasorting means an electrical switch; said switch with an input port for a power source and an output port connected to said current source end of said plurality of said optoelectronic devices.

18. A non-binary circuit assembly according to claim 14, said election voting terminal together with a plurality of count and tally apparatus;
said apparatus deriving said electrical charge from said output port of one of said first current switching means; whereby said electrical charge instigates an incremented status condition change from the prior status condition within said count and tally apparatus.

19. A non-binary circuit assembly according to claim 14, further comprising:
a second current switching means with at minimum a control port and an input port and an output port, and
a pulse generator; said pulse generator with an activation port and a signal-out port;
said data entity command means connected to said input port of said second current switching means; said output port of said second current switching means connected to said activation port of said pulse generator and also connected to said plurality of first current switching means.

20. A non-binary circuit assembly according to claim 19, together with a strobing pulse sequencer;
said pulse sequencer with a plurality of daisy-chained pulse output pins and a cease operations pin;
said cease operation pin deriving electrical command from said signal-out port of said pulse generator; one of said plurality of daisy-chained pulse output pins of said pulse sequencer connected to said control port of said second current switching means; said second current switching means follows a logic combination state whereby having raw current present at said input port and present at said control port dictates said output port commands said cease operations by action of said pulse generator and also commands said plurality of first current switching means,
with the benefit that under control of said pulse generator said first multi-port current switching means is optimized relative to time for transmitting said electrical charge through said output of said switching means.
